(19) United States
(12) Patent Application Publication
(10) Pub. No.: US 2026/0358464 A1
(43) Pub. Date: Nov. 12, 2026

(54) WIRELESS COMMUNICATION DEVICE AND DYNAMIC CHANNEL SWITCHING METHOD THEREOF

(71) Applicant: Realtek Semiconductor Corporation, Hsinchu (TW)

(72) Inventors: Cho-Han YU, Hsinchu (TW); Shau-Yu CHENG, Hsinchu (TW); Der-Zheng LIU, Hsinchu (TW)

(21) Appl. No.: 19/640,459

(22) Filed: Apr. 7, 2026

(30) Foreign Application Priority Data
May 12, 2025 (TW) 114117779

(51) Int. Cl. G01S 7/00; G01S 13/86; H04L 5/00; H04W 52/02; H04W 84/12

(52) U.S. Cl. CPC G01S 7/006; G01S 13/86; H04L 5/0062; H04L 5/0094; H04L 5/0096; H04W 52/0206; H04W 84/12

(57) ABSTRACT

A wireless communication device includes a communication circuit and a processor. The communication circuit is configured to transmit and receive wireless signals on a first wireless channel and a second wireless channel. The processor is coupled to the communication circuit, and is configured to perform the following operations: controlling the communication circuit to perform a packet transmission with a wireless access point device on the first wireless channel; switching from the first wireless channel to the second wireless channel; controlling the communication circuit to perform a radar detection on the second wireless channel; and switching from the second wireless channel to the first wireless channel after the radar detection finishes.

### CROSS - REFERENCE TO RELATED APPLICATION

This application claims priority to Taiwan Application Serial Number 114117779, filed May 12, 2025, which is herein incorporated by reference in its entirety.

### BACKGROUND

### Technical Field

The present disclosure relates to packet transmission and radar detection on wireless channels, and more particularly to a wireless communication device capable of packet transmission and radar detection and a dynamic channel switching method thereof.

### Description of the Related Art

A wireless communication device capable of transmitting and receiving radio frequency (RF) signals may utilize radio detection and ranging (i.e., radar) technology to measure data such as the distance, direction, and velocity of an object within a detection space. The principle involves periodically transmitting radar signals and analyzing the signals reflected by an object to obtain the aforementioned data when the object is present in the detection space. However, when using the wireless communication device to perform the radar detection, certain channels must be avoided to prevent interference with signals on those channels. For example, the 5 GHz band of a wireless local area network includes several dynamic frequency selection (DFS) channels. When the radar signals are detected on a DFS channel, the wireless communication device is prohibited from using this DFS channel for transmitting and receiving RF signals such as packet transmission and radar detection. Furthermore, for existing wireless communication devices, the detection range and accuracy of the radar detection are limited by the bandwidth of the wireless channel and thus cannot be effectively improved.

### SUMMARY

The present disclosure provides a wireless communication device including a communication circuit and a processor. The communication circuit is configured to transmit and receive wireless signals on a first wireless channel and a second wireless channel. The processor is coupled to the communication circuit, and is configured to perform the following operations: controlling the communication circuit to perform a packet transmission with a wireless access point device on the first wireless channel; switching from the first wireless channel to the second wireless channel; controlling the communication circuit to perform a radar detection on the second wireless channel; and switching from the second wireless channel to the first wireless channel after the radar detection finishes.

The present disclosure also provides a dynamic channel switching method adapted for a wireless communication device, in which the method includes: performing a packet transmission with a wireless access point device on a first wireless channel; switching from the first wireless channel to a second wireless channel; performing a radar detection on the second wireless channel; and switching from the second wireless channel to the first wireless channel after the radar detection finishes.

The present disclosure further provides a wireless communication device including a storage and a processor. The storage is configured to store a plurality of instructions. The processor is configured to, when accessing the storage to execute the plurality of instructions, cause the wireless communication device to perform the following operations: performing a packet transmission with a wireless access point device on a first wireless channel; switching from the first wireless channel to a second wireless channel; performing a radar detection on the second wireless channel; and switching from the second wireless channel to the first wireless channel after the radar detection finishes.

### BRIEF DESCRIPTION OF THE DRAWINGS

The disclosure can be more fully understood by reading the following detailed description of the embodiments, with reference made to the accompanying drawings as follows.

FIG. 1 is a schematic diagram of a wireless communication system according to some embodiments of the present disclosure.

FIG. 2 is a block diagram of a wireless communication device according to some embodiments of the present disclosure.

FIG. 3 illustrates an example of the wireless communication device of FIG. 2 performing packet transmission and radar detection.

FIG. 4 is a flowchart of a dynamic channel switching method according to some embodiments of the present disclosure.

### DETAILED DESCRIPTION

The following provides a detailed discussion of embodiments of the present disclosure. However, it should be understood that the embodiments provide many applicable concepts that may be implemented in various specific contexts. The disclosed embodiments are for illustrative purposes only and are not intended to limit the scope of the present disclosure.

It should be understood that, although the terms such as "first" and "second" may be used herein to describe various features, these terms should not be construed as limiting such features. These terms are only used to distinguish one feature from another.

The terms used herein are for the purpose of describing particular embodiments only and are not intended to limit the scope of the claims. Unless explicitly stated otherwise, the singular forms “a” or “the” as used herein shall also include the plural forms.

The term “coupling” and its variations may be used in the following description and claims. In certain embodiments, “coupling” may refer to two or more components that are in direct physical or electrical contact with each other, or that do not directly contact each other. “Coupling” may also refer to two or more components that interact or operate with each other.

According to current Wi-Fi system specifications, the transmission modes used by Wi-Fi systems may include, for example, orthogonal frequency division multiplexing (OFDM) transmission mode, high throughput (HT) mode, very high throughput (VHT) mode, high efficiency (HE) mode, and extremely high throughput (EHT) mode, in which the HT mode, VHT mode, HE mode, and EHT mode respectively correspond to Wi-Fi 4, Wi-Fi 5, Wi-Fi 6/6E, and Wi-Fi 7, which are different generations of WLAN standards. If the hardware specifications of the wireless communication device are better and the supported Wi-Fi system is more advanced, then more transmission modes can be used. The embodiments of the present disclosure may also support other wired and/or wireless communication technologies, such as cellular networks, Bluetooth, local area networks (LAN), and/or Universal Serial Bus (USB).

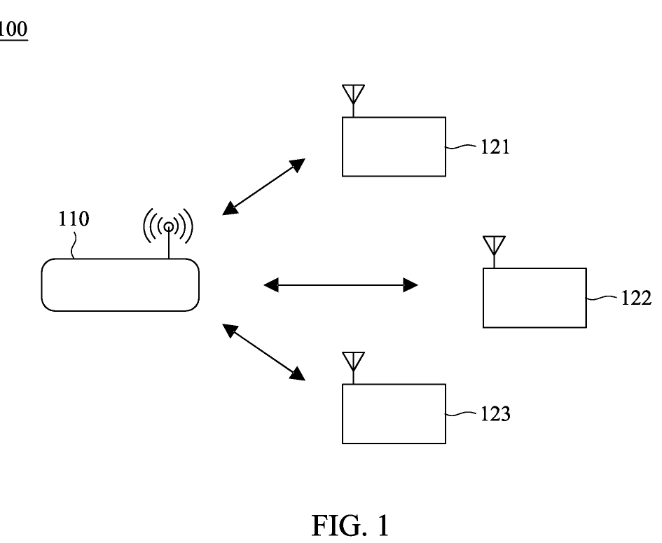

FIG. 1 is a schematic diagram of a wireless communication system 100 according to some embodiments of the present disclosure. The wireless communication system 100 includes a wireless access point device 110 and wireless station devices 121-123. The wireless access point device 110 provides wireless access services within a certain range, and each wireless station device 121-123 can communicate wirelessly with the wireless access point device 110 via Wi-Fi channels (e.g., IEEE 802.11 channels) to access a local network and/or an external network (e.g., the Internet). The wireless communication connection between the wireless access point device 110 and any of the wireless station devices 121-123 may include, but is not limited to, registration procedures, identity authentication procedures and access procedures, establishment and release of the wireless connection, and transmission and/or reception of control signals and/or data packets. Each wireless station device 121-123 may be, for example, a smartphone, tablet, laptop, or other devices equipped with wireless transceiver capabilities. Furthermore, the wireless access point device 110 may be, for example, a wireless router, a wireless switch, or a wireless transceiver device capable of access point functionality. It should be noted that the number of wireless access point devices and/or wireless station devices in the present disclosure is not limited to those shown in FIG. 1.

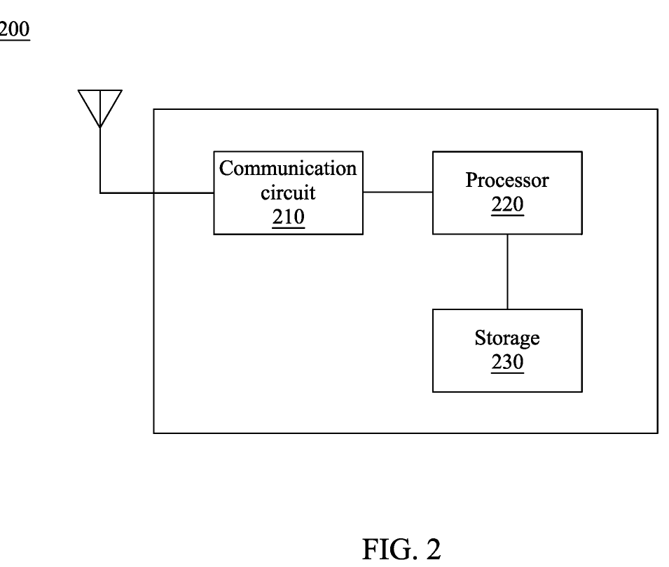

FIG. 2 is a block diagram of a wireless communication device 200 according to some embodiments of the present disclosure. The wireless communication device 200 may be any one of the wireless access point device 110 and the wireless station devices 121-123 shown in FIG. 1, or any wireless communication device that can serve as a beamforming transmitter. The wireless communication device 200 includes a communication circuit 210, a processor 220, and a storage 230. The communication circuit 210 is configured to transmit and receive radio frequency (RF) signals, such as receiving RF signals (e.g., control signals or data signals) via an antenna to demodulate the RF signals into packets, and modulating packets to be transmitted into the RF signals such that the RF signals are transmitted via the antenna. In addition, the communication circuit 210 may access a wireless local area network via Wi-Fi channels. The processor 220 is coupled to the communication circuit 210 and the storage 230, and it is configured to process the packets and determine the transmission mode of the communication circuit 210 for signal transmission and reception based on the system state. The processor 220 may be, for example, a microprocessor or an application-specific integrated circuit (ASIC), but is not limited thereto. The storage 230 may be any data storage device readable and executable by the processor 220, such as a subscriber identity module (SIM), read-only memory (ROM), erasable programmable read-only memory (EPROM), electrically erasable programmable read-only memory (EEPROM), random access memory (RAM), compact disc read-only memory (CD-ROM), magnetic tape, hard disk, solid-state drive, flash memory, or other data storage devices suitable for storing bits of data and/or code, but is not limited thereto.

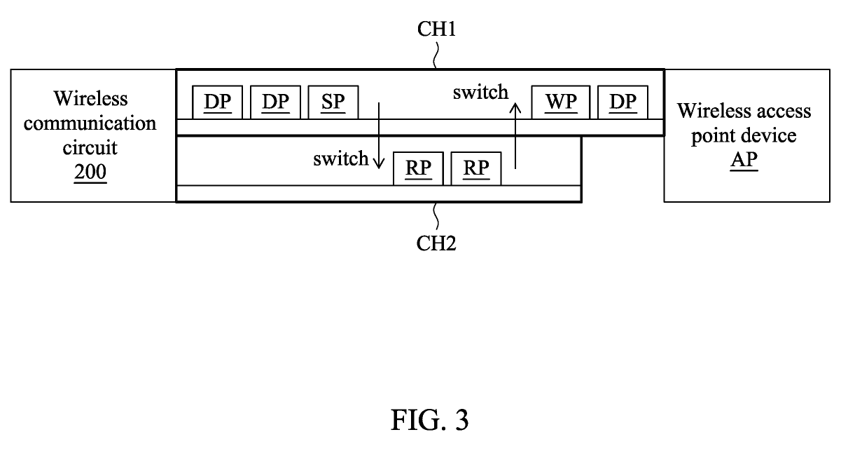

FIG. 3 illustrates an example of the wireless communication device 200 of FIG. 2 performing packet transmission and radar detection. As shown in FIG. 3, the wireless communication device 200 establishes links to the air interface, in which the links correspond respectively to wireless channels CH1 and CH2, and establishes a wireless communication connection with a wireless access point device AP via the wireless channel CH1, so as to transmit data packets DP to the wireless access point device AP on the wireless channel CH1 and to perform a radar detection on the wireless channel CH2. When switching to the wireless channel CH2 is needed (e.g., for performing the radar detection), the wireless communication device 200 may transmit a sleep packet SP to the access point device AP on the wireless channel CH1, so as to notify it that the wireless channel CH1 enters a sleep state. After switching from the wireless channel CH1 to the wireless channel CH2, the wireless channel CH1 enters a sleep mode, thereby pausing the packet transmission between the wireless communication device 200 and the access point device AP. The wireless communication device 200 then performs the radar detection on the wireless channel CH2, for example, by transmitting radar probe signals RP and receiving the signals reflected by an object. Once the wireless detection is completed, or in other situations that require switching back to the wireless channel CH1, the wireless communication device 200 switches from the wireless channel CH2 to the wireless channel CH1, and may transmit a wake-up packet WP to the access point device AP on the wireless channel CH1, so as to notify it that the wireless channel CH1 enters a wake-up state, thereby resuming the transmission of the data packets DP on the wireless channel CH1.

After the wireless channel CH1 enters the sleep mode, the wireless communication device 200 may still receive beacon frames via the wireless channel CH1. Accordingly, during the period of switching to the wireless channel CH2, the wireless communication device 200 may periodically receive beacon frames from the wireless access point device AP via the wireless channel CH1 to maintain the wireless communication connection with the wireless access point device AP. If both the wireless communication device 200 and the wireless access point device AP support the dynamic frequency selection (DFS) function, the wireless channel CH1 may be a DFS channel (e.g., Channel 120 or Channel 114 in the5 GHz band). In addition, the wireless channel CH2 may be a non-dynamic frequency selection (non-DFS) channel to avoid the interference caused by the detection signals that are transmitted by the wireless communication device 200.

In the wireless communication device 200, the processor 220 may be configured to control the communication circuit 210 to perform the packet transmission and the radar detection at different times, and also to control switching between different wireless channels. Referring to the example in FIG. 3, the communication circuit 210 is configured to transmit and receive wireless signals on the wireless channels CH1 and CH2, and the processor 220 is configured to control the communication circuit 210 to perform the packet transmission with the wireless access point device AP on the wireless channel CH1. After switching from the wireless channel CH1 to the wireless channel CH2, the processor 220 controls the communication circuit 210 to perform the radar detection on the wireless channel CH2. Once the radar detection is completed (or finishes), the wireless channel CH2 is switched back to the wireless channel CH1. Furthermore, before switching to the wireless channel CH2, the processor 220 may control the communication circuit 210 to transmit the sleep packet SP to the wireless access point device AP via the wireless channel CH1, thereby notifying the wireless access point device AP that the wireless channel CH1 enters the sleep mode and prompting it to pause the packet transmission on the wireless channel CH1. The radar detection then is performed on the wireless channel CH2. After completing the radar detection and switching from the wireless channel CH2 to the wireless channel CH1, the processor 220 may control the communication circuit 210 to transmit the wake-up packet WP to the wireless access point device AP via the wireless channel CH1, thereby notifying the wireless access point device AP that the wireless channel CH1 leaves the sleep mode and prompting it to resume the packet transmission on the wireless channel CH1. In this way, the packet transmission and radar detection can be performed without disconnecting the communication link between the wireless communication device 200 and the wireless access point device AP.

Furthermore, during the period of switching to the wireless channel CH2, the processor 220 may control the communication circuit 210 to periodically receive the beacon frames from the wireless access point device AP via the wireless channel CH1. The processor 220 may also control the communication circuit 210 to adjust the frequency band and/or bandwidth of the wireless channel CH2 according to the actual application requirements of the wireless communication device 200. For example, in order to increase the detection range and enhance the accuracy of the radar detection, the processor 220 may control the communication circuit 210 to adjust the wireless channel CH2 such that the bandwidth of the wireless channel CH2 is greater than the bandwidth of the wireless channel CH1.

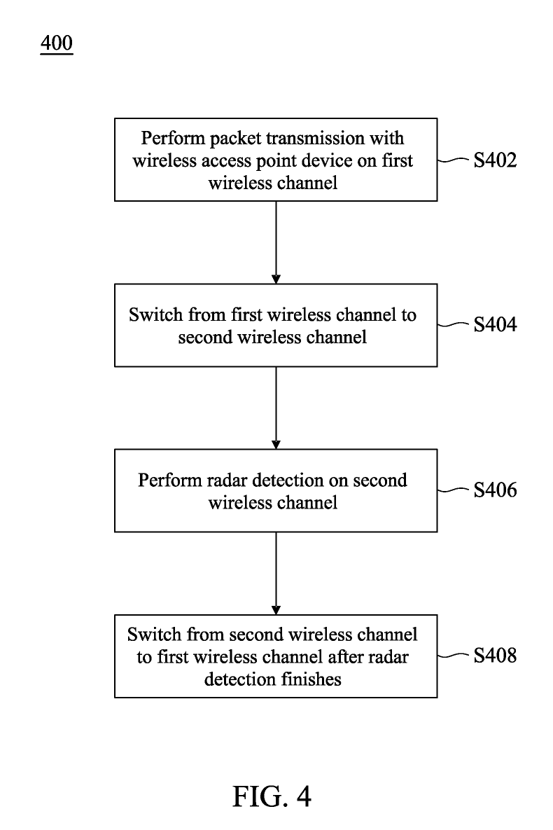

FIG. 4 is a flowchart of a dynamic channel switching method 400 according to some embodiments of the present disclosure. The channel switching example shown in FIG. 4 is adapted for a wireless communication device that supports both packet transmission and radar detection over wireless channels, such as the wireless communication device 200 of FIG. 2 or other similar wireless communication devices. The wireless communication device performing the dynamic channel switching method 400 may first establish links to the air interface, in which the links correspond respectively to a first wireless channel and a second wireless channel, and establish a wireless communication connection with a wireless access point device on the first wireless channel.

The dynamic channel switching method 400 is described as follows. First, the operation S402 is executed. The packet transmission is performed on the first wireless channel with the wireless access point device. When it is necessary to switch the wireless channel (e.g., for performing the radar detection), the operation S404 is executed to switch from the first wireless channel to the second wireless channel. The wireless communication device may transmit a sleep packet to the wireless access point device on the first wireless channel to notify it that the first wireless channel enters a sleep state. After switching to the second wireless channel, the operation S406 is executed. The radar detection is performed on the second wireless channel, such as transmitting wireless detection signals and receiving signals reflected by an object. The wireless communication device may transmit a wake-up packet to the wireless access point device on the first wireless channel to notify it that the first wireless channel leaves the sleep state. After the radar detection is completed, the operation S408 is executed to switch from the second wireless channel to the first wireless channel, so as to resume the transmission of data packets on the first wireless channel.

In the dynamic channel switching method 400, during the period of switching to the second wireless channel, the wireless communication device may periodically receive beacon frames from the wireless access point device via the first wireless channel to maintain the wireless communication connection with the wireless access point device. Furthermore, in order to increase the detection range and improve the accuracy of the radar detection, the second wireless channel can be adjusted such that the bandwidth of the second wireless channel is greater than the bandwidth of the first wireless channel. In a case where both the wireless communication device and the wireless access point device support DFS, the first wireless channel may be a DFS channel. Additionally, the second wireless channel may be a non-DFS channel to avoid the interference between the detection signals transmitted by the wireless communication device and other radar signals (e.g., military radar and/or weather radar).

The aforementioned dynamic channel switching method 400 can be programmed into instructions (e.g., computer program instructions) that may be executed by a processor and stored in a non-transitory computer-readable medium accessible by the processor. Taking the wireless communication device 200 as an example, the storage 230 may be a non-transitory computer-readable medium for storing instructions, such as ROM, flash memory, floppy disk, hard disk, optical disc, USB, flash drive, magnetic tape, a database accessible via the Internet, or other computer-readable media apparent to those skilled in the art. The processor 220 can access the storage 230 to execute the instructions, thereby causing the wireless communication device 200 to perform the operations of the dynamic channel switching method 400.

In the embodiments of the present disclosure, the wireless communication device may pre-establish links to the air interface corresponding to different wireless channels. Furthermore, the packet transmission and radar detection are performed in a time-division multiplexing manner to avoid mutual interference. Since the packet transmission and radar detection are performed on different wireless channels, the bandwidth of the wireless channel used for the radar detection is not limited by the packet transmission between the wireless communication device and the wireless access point device. Therefore, the wireless communication device in the embodiments of the present disclosure can adjust the frequency band and/or bandwidth of the wireless channel used for the radar detection according to actual application requirements. For example, increasing the bandwidth of the wireless channel used for the radar detection can extend the detection range and improve the radar detection accuracy. Because the radar detection in the embodiments of the present disclosure is performed by the existing communication circuits, these embodiments can be applied to the wireless communication devices to achieve fast switching between the packet transmission and radar detection without substantially increasing hardware costs.

In summary, the present disclosure provides a wireless communication device including a communication circuit and a processor. The communication circuit is configured to transmit and receive wireless signals on a first wireless channel and a second wireless channel. The processor is coupled to the communication circuit, and is configured to perform the following operations: controlling the communication circuit to perform a packet transmission with a wireless access point device on the first wireless channel; switching from the first wireless channel to the second wireless channel; controlling the communication circuit to perform a radar detection on the second wireless channel; and switching from the second wireless channel to the first wireless channel after the radar detection finishes. In one embodiment, the processor is configured to control the communication circuit to transmit a sleep packet to the wireless access point device via the first wireless channel before switching to the second wireless channel, so as to notify the wireless access point device that the first wireless channel enters a sleep mode. In one embodiment, the processor is configured to control the communication circuit to transmit a wake-up packet to the wireless access point device via the first wireless channel after switching to the first wireless channel, so as to notify the wireless access point device that the first wireless channel leaves the sleep mode. In one embodiment, a second bandwidth of the second wireless channel is greater than a first bandwidth of the first wireless channel. In one embodiment, the processor is further configured to control the communication circuit to periodically receive a beacon frame from the wireless access point device via the first wireless channel during a period of switching to the second wireless channel. In one embodiment, the first wireless channel is a dynamic frequency selection channel. In one embodiment, the second wireless channel is a non-dynamic frequency selection channel.

In summary, the present disclosure also provides a dynamic channel switching method adapted for a wireless communication device, in which the method includes: performing a packet transmission with a wireless access point device on a first wireless channel; switching from the first wireless channel to a second wireless channel; performing a radar detection on the second wireless channel; and switching from the second wireless channel to the first wireless channel after the radar detection finishes. In one embodiment, the dynamic channel switching method further includes transmitting a sleep packet to the wireless access point device to notify the wireless access point device that the first wireless channel enters a sleep mode before switching to the second wireless channel. In one embodiment, the dynamic channel switching method further includes transmitting a wake-up packet to the wireless access point device to notify the wireless access point device that the first wireless channel leaves the sleep mode after switching to the first wireless channel. In one embodiment, a second bandwidth of the second wireless channel is greater than a first bandwidth of the first wireless channel. In one embodiment, the dynamic channel switching method further includes periodically receiving a beacon frame from the wireless access point device via the first wireless channel during a period of switching to the second wireless channel. In one embodiment, the first wireless channel is a dynamic frequency selection channel. In one embodiment, the second wireless channel is a non-dynamic frequency selection channel.

In summary, the present disclosure further provides a wireless communication device including a storage and a processor. The storage is configured to store a plurality of instructions. The processor is configured to, when accessing the storage to execute the plurality of instructions, cause the wireless communication device to perform the following operations: performing a packet transmission with a wireless access point device on a first wireless channel; switching from the first wireless channel to a second wireless channel; performing a radar detection on the second wireless channel; and switching from the second wireless channel to the first wireless channel after the radar detection finishes. In one embodiment, the processor is further configured to, when accessing the storage to execute the plurality of instructions, cause the wireless communication device to transmit a sleep packet to the wireless access point device to notify the wireless access point device that the first wireless channel enters a sleep mode before switching to the second wireless channel. In one embodiment, the processor is further configured to, when accessing the storage to execute the plurality of instructions, cause the wireless communication device to transmit a wake-up packet to the wireless access point device to notify the wireless access point device that the first wireless channel leaves the sleep mode after switching to the first wireless channel. In one embodiment, a second bandwidth of the second wireless channel is greater than a first bandwidth of the first wireless channel. In one embodiment, the processor is further configured to, when accessing the storage to execute the plurality of instructions, cause the wireless communication device to periodically receive a beacon frame from the wireless access point device via the first wireless channel during a period of switching to the second wireless channel. In one embodiment, the first wireless channel is a dynamic frequency selection channel, and the second wireless channel is a non-dynamic frequency selection channel.

Although the present disclosure has been described in considerable detail with reference to certain embodiments thereof, the present disclosure is not limited thereto. It will be apparent to those skilled in the art that various modifications and variations can be made to the structure of the present disclosure without departing from the scope or spirit of the present disclosure. Therefore, the scope of the present disclosure shall be defined by the appended claims.

What is claimed is:

1. A wireless communication device, comprising:
a communication circuit configured to transmit and receive wireless signals on a first wireless channel and a second wireless channel; and
a processor coupled to the communication circuit and configured to perform the following operations:
controlling the communication circuit to perform a packet transmission with a wireless access point device on the first wireless channel;
switching from the first wireless channel to the second wireless channel;
controlling the communication circuit to perform a radar detection on the second wireless channel; and
switching from the second wireless channel to the first wireless channel after the radar detection finishes.

2. The wireless communication device of claim 1, wherein the processor is configured to control the communication circuit to transmit a sleep packet to the wireless access point device via the first wireless channel before switching to the second wireless channel, so as to notify the wireless access point device that the first wireless channel enters a sleep mode.

3. The wireless communication device of claim 2, wherein the processor is configured to control the communication circuit to transmit a wake-up packet to the wireless access point device via the first wireless channel after switching to the first wireless channel, so as to notify the wireless access point device that the first wireless channel leaves the sleep mode.

4. The wireless communication device of claim 1, wherein a second bandwidth of the second wireless channel is greater than a first bandwidth of the first wireless channel.

5. The wireless communication device of claim 1, wherein the processor is further configured to control the communication circuit to periodically receive a beacon frame from the wireless access point device via the first wireless channel during a period of switching to the second wireless channel.

6. The wireless communication device of claim 1, wherein the first wireless channel is a dynamic frequency selection channel.

7. The wireless communication device of claim 1, wherein the second wireless channel is a non-dynamic frequency selection channel.

8. A dynamic channel switching method, adapted for a wireless communication device, wherein the dynamic channel switching method comprises:
performing a packet transmission with a wireless access point device on a first wireless channel;
switching from the first wireless channel to a second wireless channel;
performing a radar detection on the second wireless channel; and
switching from the second wireless channel to the first wireless channel after the radar detection finishes.

9. The dynamic channel switching method of claim 8, further comprising:
before switching to the second wireless channel, transmitting a sleep packet to the wireless access point device to notify the wireless access point device that the first wireless channel enters a sleep mode.

10. The dynamic channel switching method of claim 9, further comprising:
after switching to the first wireless channel, transmitting a wake-up packet to the wireless access point device to notify the wireless access point device that the first wireless channel leaves the sleep mode.

11. The dynamic channel switching method of claim 8, wherein a second bandwidth of the second wireless channel is greater than a first bandwidth of the first wireless channel.

12. The dynamic channel switching method of claim 8, further comprising:
periodically receiving a beacon frame from the wireless access point device via the first wireless channel during a period of switching to the second wireless channel.

13. The dynamic channel switching method of claim 8, wherein the first wireless channel is a dynamic frequency selection channel.

14. The dynamic channel switching method of claim 8, wherein the second wireless channel is a non-dynamic frequency selection channel.

15. A wireless communication device, comprising:
a storage configured to store a plurality of instructions; and
a processor configured to, when accessing the storage to execute the plurality of instructions, cause the wireless communication device to perform the following operations:
performing a packet transmission with a wireless access point device on a first wireless channel;
switching from the first wireless channel to a second wireless channel;
performing a radar detection on the second wireless channel; and
switching from the second wireless channel to the first wireless channel after the radar detection finishes.

16. The wireless communication device of claim 15, wherein the processor is further configured to, when accessing the storage to execute the plurality of instructions, cause the wireless communication device to perform the following operation:
before switching to the second wireless channel, transmitting a sleep packet to the wireless access point device to notify the wireless access point device that the first wireless channel enters a sleep mode.

17. The wireless communication device of claim 16, wherein the processor is further configured to, when accessing the storage to execute the plurality of instructions, cause the wireless communication device to perform the following operation:
after switching to the first wireless channel, transmitting a wake-up packet to the wireless access point device to notify the wireless access point device that the first wireless channel leaves the sleep mode.

18. The wireless communication device of claim 15, wherein a second bandwidth of the second wireless channel is greater than a first bandwidth of the first wireless channel.

19. The wireless communication device of claim 15, wherein the processor is further configured to, when accessing the storage to execute the plurality of instructions, cause the wireless communication device to perform the following operation:
periodically receiving a beacon frame from the wireless access point device via the first wireless channel during a period of switching to the second wireless channel.

20. The wireless communication device of claim 15, wherein the first wireless channel is a dynamic frequency selection channel, and the second wireless channel is a non-dynamic frequency selection channel.
